(19) United States
(12) Patent Application Publication
(10) Pub. No.: US 2021/0302458 A1
(43) Pub. Date: Sep. 30, 2021

(54) AUTOMATED SYSTEM FOR FLUID TRANSFER IN CLEARING AND IMMUNOSTAINING OF LARGE SAMPLES

(71) Applicant: Translucence Biosystems, Inc., Irvine, CA (US)

(72) Inventors: Ricardo R Azevedo, Irvine, CA (US); Jack Zeitoun, Irvine, CA (US); Anil Verman, Irvine, CA (US)

(21) Appl. No.: 17/213,951

(22) Filed: Mar. 26, 2021

Related U.S. Application Data
(60) Provisional application No. 63/000,865, filed on Mar. 27, 2020.

(51) Int. Cl. G01N 35/10; G01N 35/00; G01N 1/30

(52) U.S. Cl. CPC G01N 35/1009; G01N 35/00029; G01N 35/1002; G01N 2035/1025; G01N 2035/00039; G01N 2035/00138; G01N 1/30

(57) ABSTRACT

The present invention features an automated fluid transfer system for tissue incubation. The system comprises a cartridge and a cartridge holder. The cartridge may hold a tissue and comprise a first and second opening to allow a fluid to enter and exit the cartridge. The cartridge holder comprises an inlet and outlet port covered by a first closure mechanism, a drainage port covered by a second closure mechanism, and a sensor. Inserting the cartridge into the cartridge holder may trigger the sensor and activate the first closure mechanism to allow the fluid to enter the sample chamber through the inlet port and for air to escape from the sample chamber through the outlet port. The tissue may incubate in the fluid for a certain amount of time. Once the tissue has finished incubating, the second closure mechanism is actuated and the fluid escapes through the drainage port.

### CROSS-REFERENCES TO RELATED APPLICATIONS

This application is a non-provisional and claims benefit of U.S. Provisional Application No. 63/000,865, filed Mar. 27, 2020, the specification(s) of which is/are incorporated herein in their entirety by reference.

### FIELD OF THE INVENTION

The present invention is directed to the clearing and immunostaining of biological samples through the use of incubation fluids. Specifically, the present invention is directed to the automation of transferring incubation fluids in a tissue clearing and immunostaining system.

### BACKGROUND OF THE INVENTION

Tissue clearing enables deep imaging of complex tissues such as whole mouse brains by rendering the tissue optically transparent. Modern tissue clearing strategies require precise control over small-volume fluid exchange and often use hazardous reagents. Currently, no automated systems exist that sufficiently allow for the fluid exchange required by tissue clearing strategies, such as iDISCO+; and none provide the chemically inert properties required to handle caustic chemicals used by process such as iDISCO+. We have invented a new system that allows for the fully automated exchange of solutions used in large scale tissue processing and clearing. Our system will reduce sample processing time, improve reproducibility, and eliminate unnecessary man-hours.

### BRIEF SUMMARY OF THE INVENTION

It is an objective of the present invention to provide automated fluid transfer systems for tissue sample incubation that allow for automated and efficient incubation of a tissue sample, as specified in the independent claims. Embodiments of the invention are given in the dependent claims. Embodiments of the present invention, and portions thereof, can be freely combined with each other if they are not mutually exclusive.

The present invention features an automated fluid transfer system for tissue sample incubation, comprising a cartridge and a cartridge holder. The cartridge may comprise a sample chamber that may hold a tissue sample, and a first and second opening for allowing fluid to travel in and out of the sample chamber. The cartridge holder may comprise a hollow body, an inlet port and an outlet port fluidly connected to the hollow body and covered by a first closure mechanism, a drainage port fluidly connected to the hollow body and covered by a second closure mechanism, and a sensor disposed within the hollow body. Inserting the cartridge into the cartridge holder triggers the sensor, actuating the first closure mechanism to allow a fluid from the inlet port to enter the sample chamber through the first opening and to allow air from within the sample chamber to escape through the first opening and through the outlet port. The tissue sample sits in the fluid until it has been sufficiently incubated, and at this point the second closure mechanism is actuated to allow the fluid to exit the sample chamber through the second opening and through the drainage port and air to enter through the outlet port.

The cartridge holder may further comprise an expansion or swivel means acting as a clamp to lock the cartridge in place. The cartridge holder may further comprise a first and second deflector for protecting the tissue sample from disruption as a result of liquid flow. A closure mechanism for an opening may be a sliding mechanism with an angled tip to reduce friction.

In different configurations, each of the three ports may be paired to any of the two openings. Any feature or combination of features described herein are included within the scope of the present invention, provided that the features included in any such combination are not incompatible or mutually inconsistent, as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIGS. 1A-1E show a method of the automated fluid transfer system of the present invention.

FIGS. 2A-2B show an embodiment of a closure mechanism of the present invention.

FIGS. 3A-3E show a method of the automated fluid transfer system of the present invention comprising a first and a second deflector.

FIGS. 4A-4B show alternative embodiments of the cartridge of the present invention.

FIG. 4C shows an alternative embodiment of the cartridge holder of the present invention.

FIGS. 5A-5E show an alternative embodiment of a system of the present invention.

FIGS. 6A and 6B show an alternative embodiment of a cartridge of the present invention.

FIGS. 6C and 6D show an alternative embodiment of a system of the present invention.

### DETAILED DESCRIPTION OF THE INVENTION

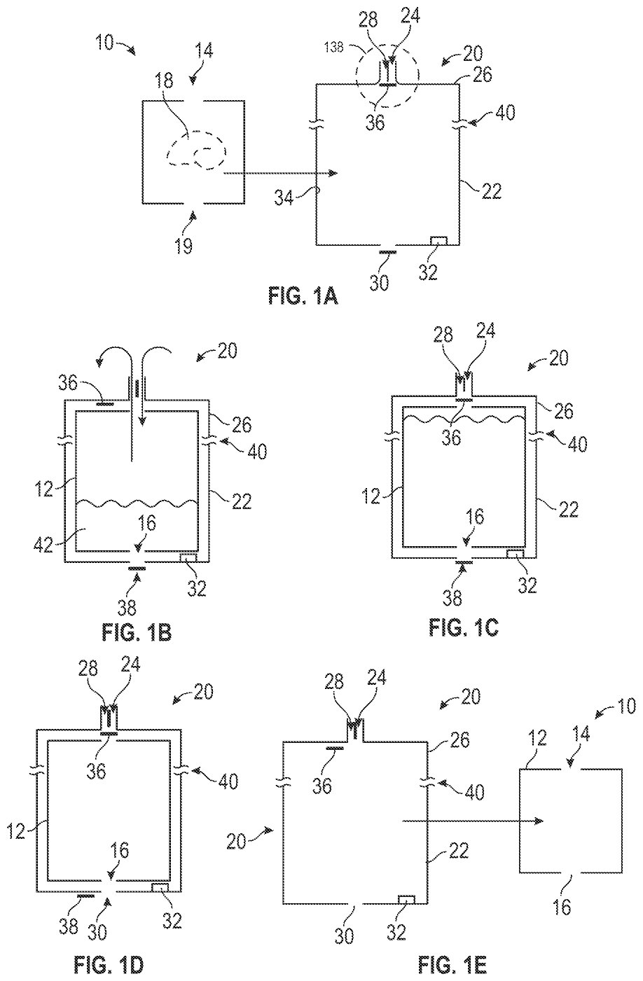

Referring now to FIGS. 1A-1E, the present invention features an automated fluid transfer system for tissue sample incubation. As seen in FIG. 1A, the fluid transfer system may comprise a cartridge 10. The cartridge 10 may comprise a sample chamber 12, a first opening 14 disposed on a surface of the sample chamber 12, and a second opening 16 disposed on the surface of the sample chamber 12. The sample chamber 12 may hold a tissue sample 18, which may comprise a whole brain. As seen in FIG. 1A, the fluid transfer system may further comprise a cartridge holder 20. The cartridge holder 20 may comprise a hollow body 22, an inlet port 24 disposed on a surface 26 of the hollow body 22, an outlet port 28 disposed on the surface 26 of the hollow body 22, a drainage port 30 disposed on the surface 26 of the hollow body 22, a sensor 32 disposed on an inner surface 34 of the hollow body 22, a first closure mechanism 36 disposed over the inlet port 24 and the outlet port 28, and a second closure mechanism 38 disposed over the drainage port 30. The cartridge 10 may be removably disposed within the hollow body 22. The first closure mechanism 36 may be actuated by the sensor 32, and the second closure mechanism 38 may be actuated an amount of time after the first closure mechanism 36 is actuated. Insertion of the cartridge 10 into the hollow body 22 may trigger the sensor 32 and actuate the first closure mechanism 36. Actuating the first closure mechanism 36 may allow a solution 42 from the inlet port 24 to enter the sample chamber 12 through the first opening 24 may allow air from the sample chamber 12 to escape through the first opening 24 and through the outlet port 28, as seen in FIG. 1B. The solution 42 may sit in the sample chamber 12 for an amount of time, as seen in FIG. 1C. Actuating the second closure mechanism 38 may allow the solution 42 to escape through the second opening 16 and through the drainage port 30, as seen in FIG. 1D. The cartridge 10 may then be removed from the cartridge holder 20, as seen in FIG. 1E. In some embodiments, the fluid transfer system further comprises an expansion means 40 acting as a clamp disposed on the inner surface 34 of the hollow chamber 26. The sensor 32 may actuate the expansion means 40 to lock the cartridge 10 in place. The expansion means 40 may utilize hydraulic means, mechanical means, pneumatic means, or combinations of two or more thereof. The sensor 32 may comprise an RF sensor, a mechanical sensor, optical sensor, or combinations of two or more thereof.

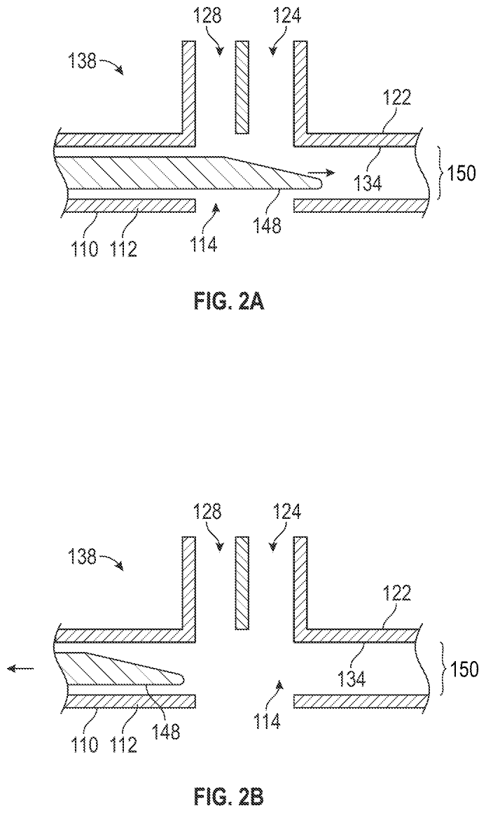

Referring now to FIGS. 2A-2B, which depict a closure subassembly 138, in some embodiments, at least one of the first and second closure mechanisms 138 may comprise a sliding mechanism 148 disposed in a gap 150 between the inner surface 134 of the hollow body 122 and an outer surface 112 of the sample chamber 110. The sliding mechanism 148 may comprise an angled tip to reduce friction, though other configurations, e.g., a blunt tip, a beveled tip, etc. FIG. 2A shows a method of closing the sliding mechanism, and FIG. 2B shows a method of opening the sliding mechanism.

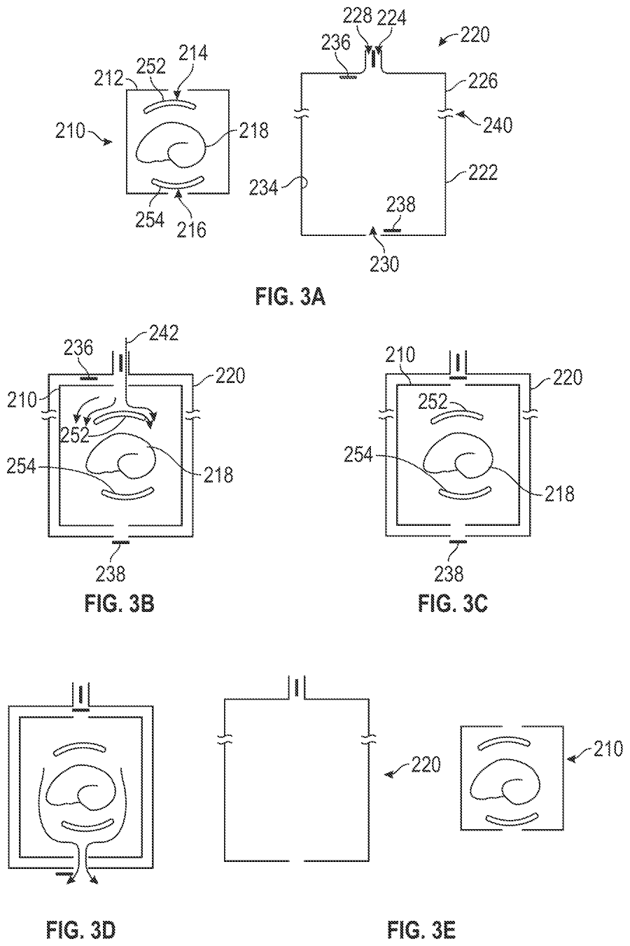

Referring now to FIGS. 3A-3E, which depict a fluid transfer system having one or more deflectors, in some embodiments, the fluid transfer system further comprises a first deflector 252 disposed within the sample chamber 212 proximate to the first opening 214 and a second deflector 254 disposed within the sample chamber 212 proximate to the second opening 216, as seen in FIG. 3A. As further seen in FIG. 3A, the fluid transfer system may further comprise a cartridge holder 220, which may comprise a hollow body 222, an inlet port 224 disposed on a surface 226 of the hollow body 222, an outlet port 228 disposed on the surface 226 of the hollow body 222, a drainage port 230 disposed on the surface 226 of the hollow body 222, a first closure mechanism 236 disposed over the inlet port 224 and the outlet port 228, and a second closure mechanism 238 disposed over the drainage port 230. The cartridge 210 may be removably disposed within the hollow body 222. The first closure mechanism 236 may be actuated, and the second closure mechanism 238 may be actuated an amount of time after the first closure mechanism 36 is actuated. Actuating the first closure mechanism 236 may allow a solution 242 from the inlet port 224 to enter the sample chamber 212 through the first opening 224 may allow air from the sample chamber 212 to escape through the first opening 224 and through the outlet port 228, as seen in FIG. 1B. The first deflector 252 may protect the tissue sample 218 (which may comprise, e.g., a whole brain) from disruption as a result of the solution 242 entering the sample chamber 212 through the first opening 214, as seen in FIG. 3B. The tissue sample 218 may incubate in the solution 242 for an amount of time, as seen in FIG. 3C. The second deflector 254 may protect the tissue sample 218 from disruption as a result of the solution 242 exiting the sample chamber 212 through the second opening 216, as seen in FIG. 3D. The cartridge 210 containing the tissue sample 218 may be removed from the cartridge holder 220, as seen in FIG. 3E. In some embodiments, at least one of the first and second deflectors 252, 254 may comprise a corrosion-resistant panel or other suitable structure or material.

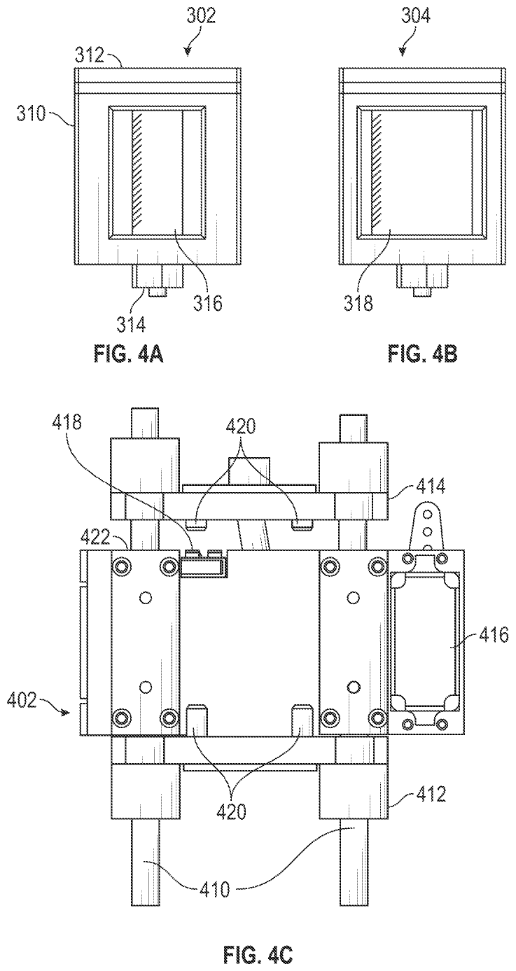

Referring now to FIGS. 4A-4C, the present invention features an alternative embodiment of the fluid transfer system. As seen in FIG. 4A, the fluid transfer system may comprise a tissue chamber 302. Another embodiment of a tissue chamber 304 appears in FIG. 4B. The tissue chamber 302 may comprise a chamber body 310, an inlet valve 312 having a sliding mechanism and allowing for fluid injection, an outlet valve 314 allowing for fluid injection, and a sample chamber 316, 318 comprising a corrosion-resistant tube where a sample may reside. A sample chamber of 5 mL 316 may be used as seen in FIG. 4A. A sample chamber of 20 mL 318 may be used as seen in FIG. 4B. As seen in FIG. 4C, the fluid transfer system may further comprise a fluid exchange station 402. The fluid exchange station 402 may comprise mounting posts 410 upon which the fluid exchange station is mounted, a bottom clamp 412 for securing the tissue chamber and sealing the outlet valve to a vacuum line, a top clamp 414 for securing the tissue chamber and inserting an injection nozzle into the sample chamber, a servo motor 416 for actuating the top and bottom clamps, a limit switch 418 for detecting insertion of the tissue chamber into the fluid exchange station, and a base mount 422 comprising a plurality of registration pins 420 for securing the tissue chamber in place.

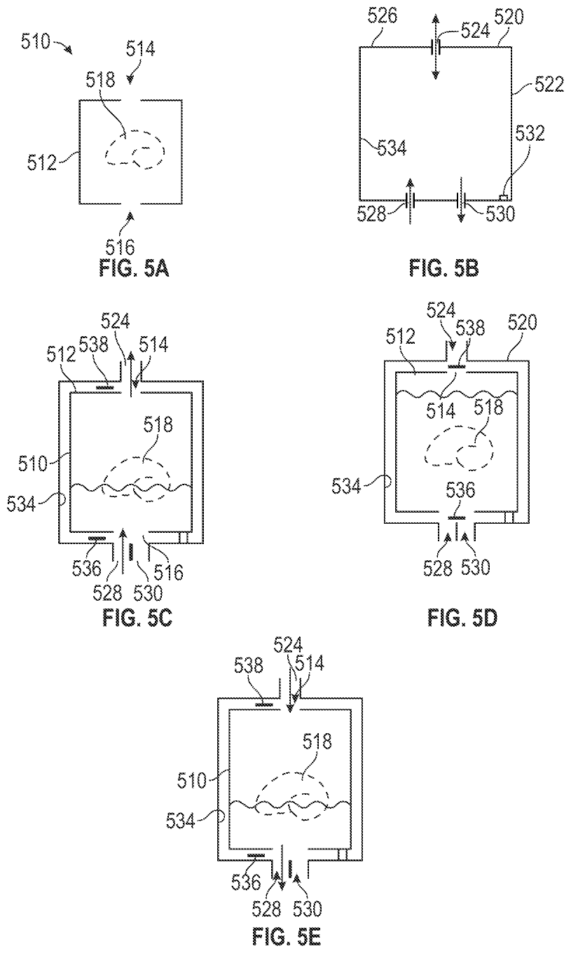

Referring now to FIGS. 5A-5E, the present invention may comprise another embodiment of an automated fluid transfer system for tissue sample incubation. As depicted in FIG. 1A, the fluid transfer system may comprise a cartridge 510. The cartridge 510 may comprise a sample chamber 512, a first opening 514 disposed on a surface of the sample chamber 512, and a second opening 516 disposed on the surface of the sample chamber 512. The sample chamber 512 may hold a tissue sample 518, which may comprise a whole brain. As depicted in FIG. 1B, the fluid transfer system may further comprise a cartridge holder 520. The cartridge holder 520 may comprise a hollow body 522, an air port 524 disposed on a surface 526 of the hollow body 522, a solution inlet port 528 disposed on the surface 526 of the hollow body 522, a solution drainage port 530 disposed on the surface 526 of the hollow body 522, a sensor 532 disposed on an inner surface 534 of the hollow body 522, a first closure mechanism 536 movably disposed over the inlet port 528 and the drainage port 530, and a second closure mechanism 538 movably disposed over first opening 514. The cartridge 510 may be removably disposed within the hollow body 522, as depicted in FIG. 5C. A solution may be introduced through solution inlet port 528 as air escapes through air port 524. The solution may be held within the cartridge 510 by back pressure from solution outlet port 530, or, in some embodiments, by closure or partial closure of the closure mechanism 538. In some embodiments, the first closure mechanism 536 may be actuated by the sensor 532 to introduce solution through solution inlet port 528 and the second closure mechanism 538 may be actuated by the sensor 532 to permit efflux of air through air port 524. Once the cartridge 510 is filled sufficiently to cover the tissue sample 518, as depicted in FIG. 5D, the first closure mechanism 536 may be actuated to close the solution inlet port 528 and the solution outlet port 530, and the second closure mechanism 538 may be actuated to close the air port 524, thereby maintaining the solution within the cartridge 510 for a period of time, e.g., for a period long enough to clear the tissue sample 518. As depicted in FIG. 5E, after a period of time, e.g., a period sufficient to clear the tissue sample 518, the first closure mechanism 536 may be actuated to allow solution to escape the cartridge 510 through solution outlet port 530 and the second closure mechanism 538 may be actuated to allow air to enter the cartridge 510 through the air port 524.

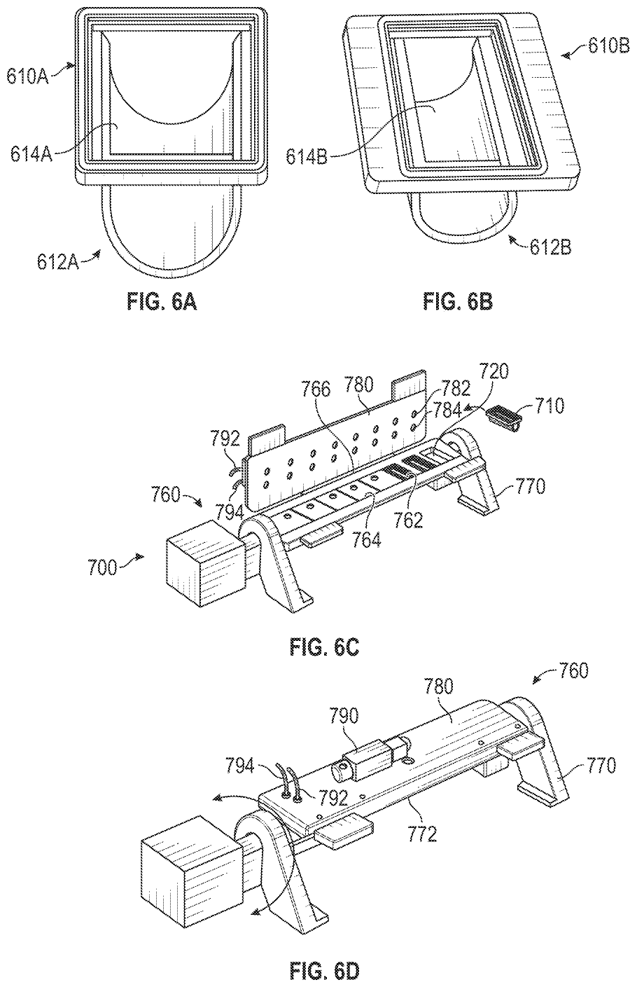

An additional embodiment of a cartridge 610A is depicted in FIG. 6A. The cartridge, 610A comprises a cartridge wall 612A, which may be a semi-cylinder or other appropriate shape. The cartridge 610A includes an opening 614A adapted for introduction of a tissue sample and solution. The cartridge 610A may have a first volume, which may be sized to receive a whole rat brain, a partial rat brain, a whole mouse brain, a partial mouse brain, etc.

Another embodiment of a cartridge 610B is depicted in FIG. 6B. The cartridge, 610B comprises a cartridge wall 612B, which may be a semi-cylinder or other appropriate shape. The cartridge 610B includes an opening 614B adapted for introduction of a tissue sample and solution. The cartridge 610B may have a volume, which may be sized to receive a whole rat brain, a partial rat brain, a whole mouse brain, a partial mouse brain, etc. The volume of the cartridge 610B may be different from the volume of the cartridge 610B.

Each cartridge 610A, 610B may be of a suitable volume, e.g., 4 mL for a half mouse brain or partial rat brain, 6 mL for a whole mouse brain, or 40 mL for a whole rat brain. A tissue sample may be placed in the cartridge 610A, 610B along with saline or other solution.

An additional embodiment of a clearing system 700 is shown in FIGS. 6C-6D. The clearing system 700 comprises one or more cartridges 710 and an automated clearing station 760, which comprises a base 770 comprising one or more cartridge holders 720 adapted to receive the one or more cartridges 710. The clearing station 760 further comprises a movable lid 780, which may be rotatably (e.g., about one or more hinges 766) coupled to the base 770. The system 700 may also comprise one or more blanks 764, which may be placed in one or more cartridge holders 720 when not in use. The movable lid may comprise a solution inlet 792 for influx of solution, and solution outlet 794 for efflux of solution, during operation of the clearing system 700. Solution may be circulated through the one or more cartridges 710 through one or more inlets 782 and outlets 784 in the lid 780. As shown by the rotation arrow, the movable lid 780 may be closed (e.g., by rotating the lid 780 about one or more hinges 766) to form a rotatable sub-assembly 772, as depicted in FIG. 6D.

As depicted in FIG. 6D, once the lid 780 is closed, a pump assembly 790 may pump solution from an external source (not shown) into the clearing station 760 through solution inlet 792 in the lid 780 and out through solution outlet 794 to a waste receptacle for disposal or recycling. Operation of the pump assembly 790 may be automated. The rotatable subassembly 772 may be rotated, e.g., up to 360°, as indicated by the rotation arrows, to assist in mixing and accelerate clearing. Such rotation may be cyclical, in either or both directions, and may be automated.

Although there has been shown and described preferred embodiments of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

What is claimed is:

1. An automated solution transfer system for tissue sample incubation comprising:
a. a cartridge comprising:
i. a sample chamber,
ii. a first opening disposed on a surface of the sample chamber, and
iii. a second opening disposed on the surface of the sample chamber,
wherein the sample chamber holds a tissue sample; and
b. a cartridge holder comprising:
i. a hollow body,
ii. an inlet port disposed on a surface of the hollow body,
iii. an outlet port disposed on the surface of the hollow body,
iv. a drainage port disposed on the surface of the hollow body,
v. a sensor disposed on an inner surface of the hollow body,
vi. a first closure mechanism disposed over the inlet port and the outlet port, and
vii. a second closure mechanism disposed over the drainage port,
wherein the cartridge is removably disposed within the hollow body,
wherein the first closure mechanism is actuated by the sensor, and
wherein the second closure mechanism actuated an amount of time after the first closure mechanism is actuated;
wherein insertion of the cartridge into the hollow body triggers the sensor;
wherein actuating the first closure mechanism allows a solution from the inlet port to enter the sample chamber through the first opening;
wherein actuating the first closure mechanism allows air from the sample chamber to escape through the first opening and through the outlet port; and
wherein actuating the second closure mechanism allows the solution to escape through the second opening and through the drainage port.

2. The system of claim 1 further comprising an expansion means acting as a clamp disposed on the inner surface of the hollow chamber.

3. The system of claim 2, wherein the sensor actuates the expansion means to lock the cartridge in place.

4. The system of claim 2, wherein the expansion means utilizes hydraulic means, mechanical means, and/or pneumatic means.

5. The system of claim 1, wherein the sensor comprises an RF sensor, an optical sensor, and/or a mechanical sensor.

6. The system of claim 1, wherein at least one of the first and second closure mechanisms is a sliding mechanism disposed in a gap between the inner surface of the hollow body and an outer surface of the sample chamber.

7. The system of claim 5, wherein the sliding mechanism comprises an angled tip to reduce friction.

8. The system of claim 1 further comprising:
a. a first deflector disposed within the sample chamber relative to the first opening; and
b. a second deflector disposed within the sample chamber relative to the second opening.

9. The system of claim 7, wherein the first deflector protects the tissue sample from disruption as a result of the solution entering the sample chamber through the first opening.

10. The system of claim 7, wherein the second deflector protects the tissue sample from disruption as a result of the solution exiting the sample chamber through the second opening.

11. The system of claim 7, wherein at least one of the first and second deflectors comprise a corrosion-resistant panel.
